(19) United States
(12) Patent Application Publication
(10) Pub. No.: US 2015/0020438 A1
(43) Pub. Date: Jan. 22, 2015

(54) ADHESIVE PEST TRAP

(71) Applicant: Bradly WORK, Prince George (CA)

(72) Inventor: Bradly WORK, Prince George (CA)

(21) Appl. No.: 14/088,181

(22) Filed: Nov. 22, 2013

Related U.S. Application Data
(60) Provisional application No. 61/847,964, filed on Jul. 18, 2013.

(51) Int. Cl. A01M 1/14; A01M 1/20

(52) U.S. Cl. CPC A01M 1/14; A01M 1/2005
USPC 43/114; 43/132.1

(57) ABSTRACT

An adhesive pest trap is provided, that includes: a substantially planar substrate having first and second substantially parallel surfaces and an outer perimeter, wherein the first surface includes a non-drying adhesive material coating, and wherein the outer perimeter is configured for fitting within a rim of a plant growing container. In one example, an adhesive pest trap can be adapted to cover a soil surface in a plant growing container, where a perimeter of the adhesive pest trap additionally includes one or more attachable surfaces adapted for attachment to a rim of a plant growing container. A related method of using an adhesive pest trap includes applying the adhesive pest trap over a top surface of a plant growing medium in a plant growing container.

### 1. CROSS-REFERENCE TO RELATED APPLICATIONS

This application is related and claims priority to U.S. Provisional Patent Application No. 61/847,964 filed Jul. 18, 2013, the contents of which are hereby incorporated herein by reference in their entirety.

### 2. TECHNICAL FIELD

The present invention relates generally to adhesive or non-drying glue based pest traps. More specifically, the present invention relates to adhesive or non-drying glue based pest traps which are adapted to be applied to cover the soil surface of a plant growing container to protect a growing plant from pests, and methods of use thereof.

### 3. BACKGROUND OF THE INVENTION

The widespread adoption of greenhouse or otherwise indoor horticulture and/or agriculture involving growing plants inside plant pots or growing containers has lead to a need for improved methods of controlling pests who feed on or otherwise damage such plant pot or container-grown plants. In particular, there is a desire for improved traps for trapping or otherwise stopping or repelling pests, such as insects, arthropods, larvae, and others, that may crawl or land on, or burrow into soil surfaces in plant pots or containers so as to attack or otherwise disturb plants growing in the pots or containers. Examples of such pests may include but are not limited to gnats, aphids, whiteflies, spider mites, thrips, fruit flies and other types of flies, caterpillars, larvae, leafminers and fungus pests.

Many types of insect traps designed to capture and/or kill insects, both flying and crawling, have been proposed. One type of such traps use non-drying glues or other adhesives to trap insects by adhesive contact. Insect traps using such adhesive methods are well known and include coiled flypaper ribbons, and hanging flypaper sheets and/or boards. Other more complex known traps include non-drying glue or adhesive components with additional complexities such as trap enclosures or containers, attractants such as lights, and various shipping and/or storing capabilities.

However, existing insect trap products have been found to have limitations which have undesirably limited their usefulness and/or commercial success. They may be messy to deploy, unpleasant to look at or use, expensive or narrowly useful, or ineffective in use, among other limitations. They may also be unsuitable, inefficient or ineffective for application to pest control for plants growing in pots or plant containers.

Accordingly, there remains a desire for improved adhesive pest traps and methods for their application that address some of the limitations of the adhesive pest traps known in the art.

### 4. SUMMARY OF THE INVENTION

It is an object of the present invention to provide an adhesive pest trap that addresses some of the limitations of the prior art.

An adhesive pest trap is provided, that includes: a substantially planar substrate having first and second substantially parallel surfaces and an outer perimeter, wherein said first surface comprises a non-drying adhesive material coating, and wherein said outer perimeter is configured for fitting against a rim of a plant growing container.

A further object of the present invention is to provide an adhesive pest trap that is adapted to cover a soil surface in a plant growing container, wherein a perimeter of the adhesive pest trap additionally includes one or more attachable surfaces adapted for attachment to a rim of a plant growing container.

Another object of the present invention is to provide a method of using an adhesive pest trap comprising providing an adhesive pest trap, the method comprising providing an adhesive pest trap comprising a substantially planar substrate having first and second substantially parallel surfaces and an outer perimeter, wherein said first surface comprises a non-drying adhesive material coating, and wherein said outer perimeter is configured for fitting against a rim of a plant growing container, and applying the adhesive pest trap over the top surface of a plant growing medium in a plant growing container.

Further advantages of the invention will become apparent when considering the drawings in conjunction with the detailed description.

### 5. BRIEF DESCRIPTION OF THE DRAWINGS

The apparatus and methods of the present invention will now be described with reference to the accompanying drawing figures, in which:

FIG. 1 is a plan view of an adhesive pest trap according to an embodiment of the present invention.

FIG. 2 is a top perspective view of an adhesive pest trap, according to an embodiment of the invention.

FIG. 3 is a top perspective isometric view of an adhesive pest trap applied to a soil surface of a plant growing container, according to a further embodiment of the present invention.

FIG. 4 is a perspective side view of an adhesive pest trap, according to an embodiment of the invention.

### 6. DETAILED DESCRIPTION OF THE INVENTION

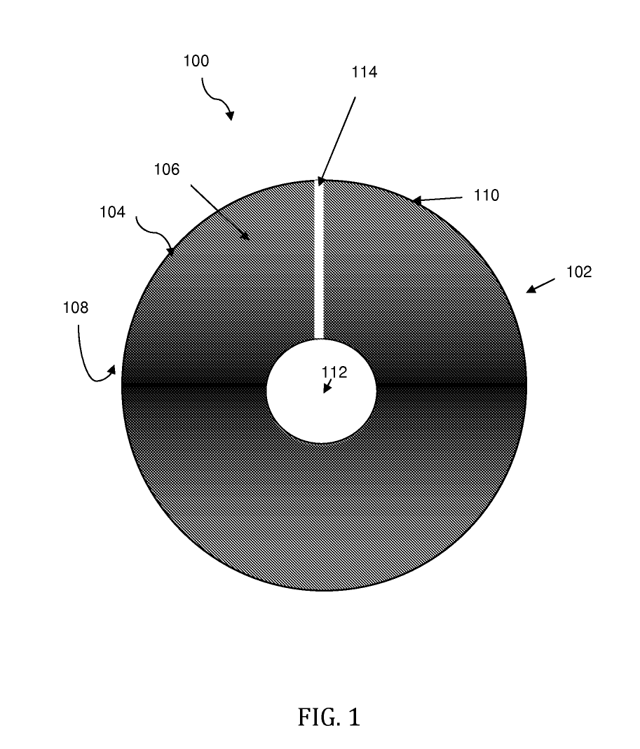

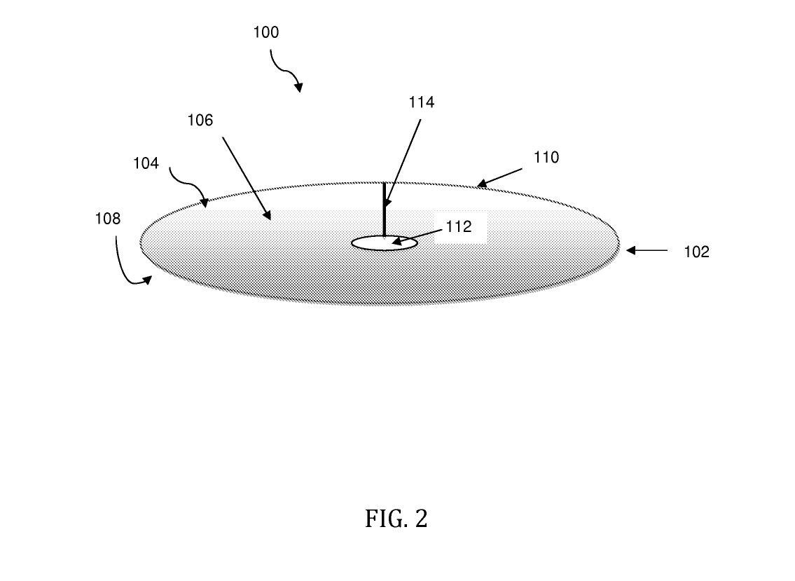

Referring to FIGS. 1 and 2, plan and top perspective views of an adhesive pest trap 100 are shown, according to embodiments of the present invention. The adhesive pest trap 100 comprises a generally thin and substantially planar substrate material 102, having first and second, or top and bottom, substantially parallel surfaces. A first, or top, surface 104 also comprises a coating or layer of adhesive material 106 covering substantially the entire top surface 104 of the substrate material 102, such as a non-drying adhesive or glue-like material, for example. A second, or bottom surface 108 of substrate material 102 is located on the opposite side of the substrate material 102 from the first or top surface 104. In one embodiment, the outer perimeter 110 of the substrate material 102 may be shaped and sized to fit within a plant growing container such as a plant pot or box or against an outer rim of a plant container, and may therefore be shaped substantially as a circle in the case of a substantially circular plant growing pot, or a rectangle in the case of a rectangular plant growing box, for example.

In one embodiment, the adhesive pest trap 100 also comprises a central hole or opening 112 which may desirably be sized and spaced so as to allow for a plant stalk or stem to protrude through the hole 112. In another embodiment, the adhesive pest trap 100 may also further comprise a slit 114 extending from the outer perimeter 110 of the adhesive pest trap 100 towards a substantially central area of the adhesive pest trap 110, so as to allow the trap to be placed around the existing stalk or stem of a plant growing out of a plant growing container. In yet another embodiment, the adhesive pest trap 100 may comprise both a central hole or opening 112 and a slit 114 extending between the central hole 112 and the outer perimeter 110 of the pest trap 100, so as to provide for placement of the trap around an existing plant stalk or stem having a substantial diameter growing out of a plant growing container, for example.

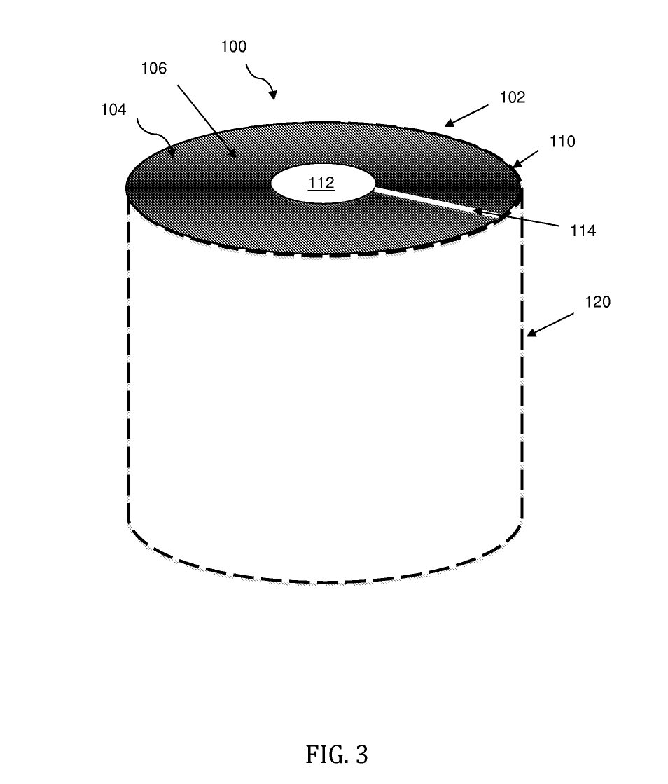

Referring now to FIG. 3, a top perspective view of an adhesive pest trap 100 applied to or placed on top of the upper surface of a plant growing medium in a plant growing container 120 is shown, according to a further embodiment of the present invention. A first, or top, surface 104 comprises a coating or layer of adhesive material 106 covering or overlying substantially the entire top surface 104 of the substrate material 102, such as a non-drying adhesive or glue-like material 106, for example. In a particular embodiment, the perimeter 110 of the adhesive pest trap 100 may be sized and shaped to fit within a cooperating plant growing container 120 and preferably cover substantially all of the exposed upper surface of a soil substrate or other plant growing substrate located within the plant growing container 120, such that the substrate material 102 preferably fits substantially adjacent to or against the outside edge or rim of the plant growing container 120, and more preferably fits substantially snugly and/or sealingly against the outside edge or rim of the plant growing container 120, such as to substantially prevent pests from entering into the soil or other plant growing substrate from the top of the plant growing container, for example. In another embodiment, the perimeter 110 of the pest trap may be sized and shaped to fit over the outside edge of the plant container.

In one embodiment of a related method of using an adhesive pest trap, a pest trap 100 is provided and configured for fitting substantially adjacent to or against or sealingly against the outside edge of the plant growing container 120, and the pest trap 100 is then placed over the top surface of the plant growing medium inside the plant growing container. In one such embodiment, the pest trap 100 may be configured and placed in the plant growing container so as to substantially cover all of the top surface of the plant growing medium inside the container, and further may preferably be fitted substantially snugly and/or sealingly against the outside edge or rim of the container 120, such as to substantially prevent pests from entering into the soil or other plant growing substrate from the top of the plant growing container, for example. In another embodiment, the perimeter 110 of the pest trap 100 may be sized and shaped to fit over the outside edge of the plant container, and may be placed over the outside edge of the container over top of the plant growing medium within.

In one embodiment of the present invention suited for use with a cooperating round plant growing container such as a round plant pot 120, the adhesive pest trap 100 may comprise a substantially circular substrate material 102 with a circular shaped perimeter 110, which may be sized to fit closely and/or sealingly against the round edge of the plant growing container 120 and to cover or overlie substantially all of the upper surface of a soil or other plant growing medium within the plant growing container 120. In another embodiment, suited for use with a cooperating rectangular plant growing container, such as a rectangular or square plant box for example, the adhesive pest trap 100 may comprise a substantially rectangular substrate material 102 with a rectangular shaped perimeter 110, which may be dimensioned to match the cooperating rectangular plant growing container and to fit closely and/or sealingly against the rectangular edge of the plant growing container and cover or overlie substantially all of the upper surface of a soil or other plant growing medium within the plant growing container 120.

In a particular embodiment, an outer portion of the perimeter 110 of the substrate 102 may be specifically adapted to provide a sealing attachment to or against the outer edge of a plant growing container 120, such as by provision of one or more attachable portions of the perimeter 110 of the substrate 102, which may be attached, such as by adhesive or mechanical means, to the plant growing container 120, so as to effectively secure and/or seal the adhesive trap 100 to the container 120, for example. In one such optional embodiment, one or more adhesive edges or tabs at the perimeter 110 of the substrate 102 may be adapted to sealing attachment to the plant growing container 120, for example. In another embodiment, the adhesive pest trap 100 may also comprise a removable covering layer (not shown) which may be removably placed over the top of the adhesive material 106, such as for transport, sale and/or relocation of the pest trap 100, to substantially cover the adhesive material 106 with a non-adhesive surface such as to protect the adhesive material 106 and/or prevent unwanted adhesion of the adhesive material to other objects before placement on a plant growing container, for example. In one such embodiment, the removable covering layer (not shown) may comprise a thin plastic film which is substantially non-adhesive and may be easily removed and/or replaced over the adhesive material 106.

In an optional embodiment, the adhesive pest trap 100 may also comprise a central hole or opening 112 which may desirably be sized and spaced so as to allow for a plant stalk or stem to protrude through the hole 112. In another optional embodiment, the adhesive pest trap 100 may also further comprise a slit 114 extending from the outer perimeter 110 of the adhesive pest trap 100 towards a substantially central area of the adhesive pest trap 110, so as to allow the trap to be placed around the existing stalk or stem of a plant growing out of a plant growing container 120. In yet another embodiment, the adhesive pest trap 100 may comprise both a central hole or opening 112 and a slit 114 extending between the central hole 112 and the outer perimeter 110 of the pest trap 100, so as to provide for placement of the trap around an existing plant stalk or stem having a substantial diameter growing out of a plant growing container 120, for example. In one exemplary embodiment adapted for use with a standard round plant growing container commonly used in greenhouse horticulture and/or agriculture and having an internal diameter of 11 inches, an adhesive pest trap 100 may comprise a substantially round substrate 102 having an outer diameter of 11 inches, and a thickness of approximately 1 mil, with a substantially circular central opening approximately 3 inches in diameter, for example, where the adhesive material 106 covers substantially the entire top surface 104 of the substrate 102.

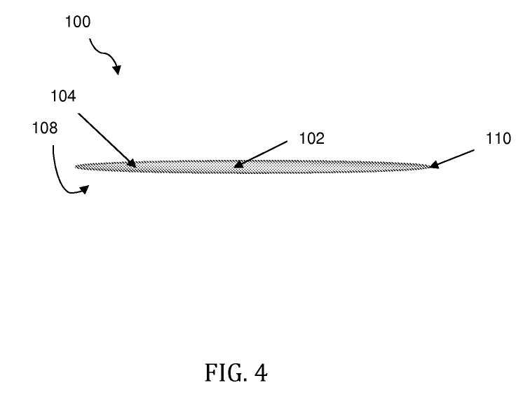

Referring now to FIG. 4, a perspective side view of an adhesive pest trap 100, according to an embodiment of the present invention, is shown. Substantially similar to the embodiments shown in FIGS. 1-3, the substrate 102, top adhesive surface 104, bottom surface 108, and perimeter 110 of the adhesive pest trap 100 are shown is the perspective side view of FIG. 4.

In one embodiment according to the present invention, the substrate material 102 of the adhesive pest trap 100 may comprise any suitable substantially planar or sheet-like substrate material suitable for placement on top of a soil or other plant growing medium in a plant growing container or on top of a perimeter or rim of the container, and for receiving the application of a layer or surface of adhesive material 106, such as an adhesive layer comprising a non-drying adhesive or glue, to its top or outer surface 104. In a particular embodiment, the substrate material 102 may comprise any suitable substrate material which may be flexible, pliable, semi-rigid or substantially rigid, so as to provide for support for and adhesion of the adhesive material 106 to the top or outer surface 104 of the substrate 102, and for supporting the adhesive pest trap 100 when placed in contact with or overlying the top surface of soil or another plant growth medium inside a plant growing container 120. In one such embodiment, the substrate material 102 may be selected from substantially planar suitable such materials including but not limited to paper, fabric, cardboard, plastic, cellulose, polymer sheet, metallic foil, metalized polymer foil, or other suitable substrate material, for example.

In a particular embodiment, the second or bottom surface 108 of the substrate 102 may be substantially uncoated and free of adhesive material, such as to allow for easy placement and/or removable placement of the substrate 102 on a soil or plant growing medium such as inside a plant growing container 120, for example. In another embodiment, the bottom surface 108 of the substrate may comprise any desired coating or other material suitable for improving the placement of the substrate 102 on a soil or growing medium, such as a mesh or reinforcing coating or material, or a waterproof coating or material, for example, or may comprise a coating or other material suitable to attach or seal to a perimeter or rim of a plant growing container, such as an adhesive attachment or sealing coating or material, for example. In yet another embodiment, the substrate material 102 may itself comprise a water-resistant or substantially waterproof material, for example, or may alternatively comprise a water-permeable material if desired. In a further embodiment, the substrate 102 may comprise a material selected to be attractive to one or more type of pests desired to be trapped by the adhesive pest trap 100, such as a particular color of material attractive to one or more type of pests, or may comprise a coating or additive which may comprise an attractant to attract one or more type of pest, such as one or more of a coloring, scent, pheromone, or other pest attractant, for example. In an exemplary such embodiment, at least one of the substrate material and/or a coating or additive applied to or added to the substrate material may desirably be provided in any suitable color, such as but not limited to light colors, bright colors, dark colors, or any other suitable color, or combination or range of colors suited for attracting one or more type of pests. In an alternative embodiment, it may be desirable to employ any suitable substrate material, and/or a coating or additive applied to or added to the substrate material that may act to repel one or more type of pest, such as one or more of a coloring, scent, pheromone or other pest repellent, for example.

In another embodiment of the present invention, the adhesive material 106 coating or otherwise applied to at least a portion of the top surface 104 of the substrate 102 may desirably comprise any suitable adhesive material operable for adhesively trapping or otherwise stopping, slowing, repelling or capturing one or more targeted types of pests, such as insects, arthropods, larvae or other types of pests, on the top surface of the adhesive pest trap 100. In one such embodiment, the adhesive material 106 may comprise any suitable tacky or adhesive material, such as non-drying adhesive or glue-based materials as may be known for applications such as flypaper or glueboards, for example. In a particular embodiment, such non-drying adhesive or glue based materials may comprise rubber, polymer, latex, petroleum, oilseed based or any other suitable organic and/or inorganic types of tacky, glue-like or adhesive materials, for example. In a preferred embodiment of the present invention, the adhesive material 106 may desirably comprise a substantially environmentally friendly or non-toxic non-drying glue or adhesive material. In a further embodiment, the adhesive material 106 may additionally comprise one or more additive, such as but not limited to an attractant (such as a colour, scent, and/or pheromone for example) which may be attractive to one or more type of pest, or an insecticide and/or pesticide active against at least one type of pest.

In an optional embodiment of the present invention, the adhesive pest trap 100 may be adapted for placement on or over a plant growing container but not in direct contact with the surface of the soil or plant growth medium in the plant growing container. In one embodiment of a related method of using an adhesive pest trap, the pest trap 100 may be suspended above the surface of the soil or plant growing medium in a plant growing container, such as by one or more sticks, pins, stakes, or other suitable means, such that the trap 100 is located above the soil surface, but underneath the foliage of a plant growing in the soil, for example. In another such embodiment, the pest trap 100 may be fitted and/or attached to the inside or outside rim of the plant growing container, such that the adhesive pest trap 100 is suspended above the surface of the soil or plant growing medium inside the plant growing container, such as by attachment or seal to the upper inside or outside rim surfaces of the plant growing container, for example. In one such embodiment, attachment or sealing of the adhesive pest trap 100 to the upper rim surface of the plant growing container may be by adhesive means, such as by adhesion of an adhesive material, such as the adhesive material 106, to the rim of the plant growing container, for example.

The exemplary embodiments herein described are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of the foregoing disclosure, many alterations and modifications are possible in the practice of this invention without departing from the scope thereof.

What is claimed is:

1. An adhesive pest trap comprising a substantially planar substrate having first and second substantially parallel surfaces and an outer perimeter, wherein said first surface comprises a non-drying adhesive material coating, and wherein said outer perimeter is configured for fitting against a rim of a plant growing container.

2. The adhesive pest trap according to claim 1, wherein said outer perimeter is additionally configured for sealing engagement with the rim of a plant growing container.

3. The adhesive pest trap according to claim 1, wherein said substrate comprises at least one of a substantially circular and substantially rectangular shape.

4. The adhesive pest trap according to claim 1, wherein at least one of said substrate and said non-drying adhesive material comprises a pest attractant.

5. The adhesive pest trap according to claim 1, wherein at least one of said substrate and said non-drying adhesive material comprises a pesticide.

6. The adhesive pest trap according to claim 1, wherein at least one of said substrate and said non-drying adhesive material comprises an insecticide.

7. The adhesive pest trap according to claim 1, additionally comprising a removable covering layer disposed on top of said adhesive material layer upon said first surface.

8. The adhesive pest trap according to claim 1, wherein said perimeter comprises one or more attachable surfaces adapted for attachment to a rim of a plant growing container.

9. The adhesive pest trap according to claim 1, additionally comprising a central hole.

10. The adhesive pest trap according to claim 9, additionally comprising a slit extending between said central hole and said outer perimeter.

11. The adhesive pest trap according to claim 1, wherein said substantially planar substrate comprises a material selected from the list comprising: paper, fabric, cardboard, plastic, cellulose, polymer, metallic foil, metalized polymer foil, and combinations thereof.

12. The adhesive pest trap according to claim 1, wherein said substantially planar substrate comprises at least one of a water-resistant and waterproof material.

13. The adhesive pest trap according to claim 1, wherein said second surface is uncoated.

14. The adhesive pest trap according to claim 1, wherein said second surface comprises at least one sealing material coating configured for attachment of said second surface to at least one of said plant growing container and a plant growing medium.

15. The adhesive pest trap according to claim 1, wherein at least one of said substrate and said non-drying adhesive material comprises a pest repellent.

16. The adhesive pest trap according to claim 1, wherein said second surface comprises at least one reinforcing material.

17. A method of using an adhesive pest trap comprising providing an adhesive pest trap comprising a substantially planar substrate having first and second substantially parallel surfaces and an outer perimeter, wherein said first surface comprises a non-drying adhesive material coating, and wherein said outer perimeter is configured for fitting against a rim of a plant growing container, and applying said adhesive pest trap over a top surface of a plant growing medium inside said plant growing container.

18. The method according to claim 17, wherein said adhesive pest trap is applied directly onto said top surface of said plant growing medium.

19. The method according to claim 17, wherein said adhesive pest trap is applied over said top surface of said plant growing medium by suspending said adhesive pest trap above said top surface of said plant growing medium in said plant growing container.

20. The method according to claim 17, wherein said method additionally comprises sealing said adhesive pest trap against said rim of said plant growing container.
